(19) United States
(12) Patent Application Publication
(10) Pub. No.: US 2026/0065332 A1
(43) Pub. Date: Mar. 5, 2026

(54) PRINTING DEVICE MANAGEMENT DEVICE, PRINTING DEVICE MANAGEMENT METHOD, PRINTING DEVICE MANAGEMENT PROGRAM, PRINTING DEVICE MANAGEMENT SYSTEM, AND PRINTING DEVICE

(71) Applicant: MIMAKI ENGINEERING CO., LTD., Nagano (JP)

(72) Inventors: Yu Kawabata, Nagano (JP); Yukinari Kobayashi, Nagano (JP)

(73) Assignee: MIMAKI ENGINEERING CO., LTD., Nagano (JP)

(21) Appl. No.: 19/106,232

(22) PCT Filed: Nov. 28, 2023
(86) PCT No.: PCT/JP2023/042437

§ 371 Date: Feb. 25, 2025

(30) Foreign Application Priority Data
Nov. 29, 2022 (JP) 2022-190545

(51) Int. Cl. G06Q 30/0283; G06Q 10/20

(52) U.S. Cl. CPC G06Q 30/0283; G06Q 10/20

(57) ABSTRACT

An appropriate maintenance contract fee for maintenance work of a printing device is calculated. A printing device management device includes a maintenance information deriving unit that derives maintenance information related to an occurrence risk of a maintenance work of a printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device, an evaluation unit that derives an evaluation for a user of the printing device based on the maintenance information and at least one of a usage amount and a purchase amount of a consumable used in the printing device, and a fee calculation unit that calculates a maintenance contract fee for maintenance work of the printing device based on the derived evaluation of the user.

### TECHNICAL FIELD

The present invention relates to a printing device management device, a printing device management method, a printing device management program, a printing device management system, and a printer.

### BACKGROUND ART

Printing devices such as inkjet printers are used in various places such as general homes, offices, and factories. Such printing devices are used in a variety of ways and in a variety of environments, and the types and frequency of abnormalities that occur and the maintenance work that is required also differ depending on the user.

A manufacturer of such a printing device has a maintenance contract with a user, and performs maintenance and repair of the printing device owned by the user based on the maintenance contract. For example, there is known a technique of determining priority information indicating a maintenance priority in a case where an abnormality occurs in a printing device based on at least one of device information indicating a state of the printing device owned by a user, use information indicating a usage state of the printing device, and contract information related to a maintenance contract between the user and a manufacturer (see, for example, Patent Literature 1).

### CITATION LIST

### Patent Literature

Patent Literature 1: Japanese Unexamined Patent Publication No. 2021-43660

### SUMMARY OF INVENTION

### Technical Problems

Such a maintenance service for performing maintenance work of the printing device is often a fixed amount of periodic maintenance contract. Therefore, as the number of times of dispatch of maintenance workers on the manufacturer side is large, the number of times of free replacement of maintenance components is large, and the maintenance components to be replaced with free replacement are expensive, the loss on the manufacturer side increases. On the other hand, the user who uses the maintenance service less during the contract period pays the periodic maintenance contract cost more than necessary. For this reason, it is required to conclude a periodic maintenance contract with an appropriate maintenance contract fee between the manufacturer and the user.

The present invention has been made in view of the above, and an object of the present invention is to provide a printing device management device, a printing device management method, a printing device management program, a printing device management system, and a printing device capable of calculating an appropriate maintenance contract fee for maintenance work of the printing device.

### Solutions to Problems

A printing device management device according to the present invention includes a maintenance information deriving unit that derives maintenance information related to an occurrence risk of a maintenance work of a printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device, an evaluation unit that derives an evaluation for a user of the printing device based on the maintenance information and at least one of a usage amount of a consumable used in the printing device and a purchase amount of the consumable, and a fee calculation unit that calculates a maintenance contract fee for maintenance work of the printing device based on the derived evaluation of the user.

A printing device management method according to the present invention includes a maintenance information deriving step of deriving maintenance information related to an occurrence risk of a maintenance work of a printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device, an evaluation step of deriving evaluation of a user of the printing device based on the maintenance information and at least one of a usage amount of a consumable used in the printing device and a purchase amount of the consumable, and a fee calculation step of calculating a maintenance contract fee for maintenance work of the printing device based on the derived evaluation of the user.

A printing device management program according to the present invention causes a computer to execute a maintenance information deriving step of deriving maintenance information related to an occurrence risk of a maintenance work of a printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device, an evaluation step of deriving evaluation for a user of the printing device based on the maintenance information and at least one of a usage amount of a consumable used in the printing device and a purchase amount of the consumable, and a fee calculation step of calculating a maintenance contract fee for maintenance work of the printing device based on the derived evaluation of the user.

A printing device management system according to the present invention includes a printing device, and a management device that is communicable with the printing device and manages the printing device, in which the printing device management device is used as the management device.

A printing device according to the present invention includes a maintenance information deriving unit that derives maintenance information related to an occurrence risk of a maintenance work of the printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device, and an evaluation unit that derives an evaluation of a user of the printing device based on the maintenance information and at least one of a usage amount of a consumable used in the printing device and a purchase amount of the consumable.

### EFFECT OF THE INVENTION

According to the present invention, an appropriate maintenance contract fee for maintenance work of the printing device can be calculated.

### BRIEF DESCRIPTION OF THE DRAWINGS

FIG. 1 is a diagram illustrating an example of a printing device management system according to the present embodiment.

FIG. 2 is a flowchart illustrating an example of a printing device management method according to the present embodiment.

FIG. 3 is a flowchart illustrating an example of processing contents of a maintenance information deriving step.

FIG. 4 is a diagram schematically illustrating an example of maintenance information derived in a maintenance information deriving step.

FIG. 5 is a flowchart illustrating an example of processing contents of an evaluation step.

FIG. 6 is a diagram schematically illustrating an example of evaluation derived in the evaluation step.

FIG. 7 is a flowchart illustrating an example of processing contents of a fee calculation step.

FIG. 8 is a diagram schematically illustrating an example of a maintenance contract fee calculated in the fee calculation step.

FIG. 9 is a flowchart illustrating an example of processing contents of a related information deriving step.

### DESCRIPTION OF EMBODIMENTS

Hereinafter, embodiments of a printing device management device, a printing device management method, a printing device management program, a printing device management system, and a printing device according to the present invention will be described with reference to the drawings. Note that the present invention is not limited by the embodiment. In addition, constituent elements in the following embodiments include those that can be easily replaced by those skilled in the art or those that are substantially the same.

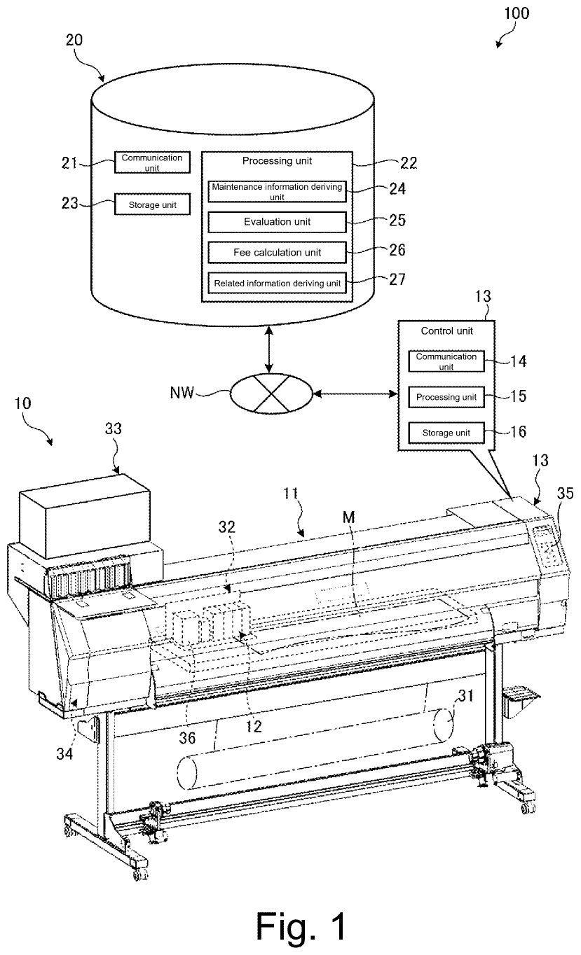

FIG. 1 is a diagram illustrating an example of a printing device management system 100 according to the present embodiment. As illustrated in FIG. 1, the management system 100 includes a printing device 10 and a management device 20. In the present embodiment, the printing device 10 and the management device 20 are connected via a network NW such as the Internet, for example.

The printing device 10 includes a main body 11, a head 12, and a control unit 13. In the present embodiment, the printing device 10 is an inkjet type printing device. The main body 11 includes parts that perform printing operations and related operations, such as a transport unit 31 that transports a medium M, a head drive unit 32 that moves the head 12, an ink supply unit 33 that supplies ink to the head 12, a cleaning unit 34 that cleans the head 12, an operation panel 35 for operating the printing device 10, and an ultraviolet irradiation unit 36 that irradiates the ink with ultraviolet light. The head 12 ejects ink onto the medium M. The control unit 13 integrally controls each unit of the main body 11 and the head 12.

The control unit 13 includes a communication unit 14, a processing unit 15, and a storage unit 16. The communication unit 14 performs wired or wireless communication with an external device including the management device 20. The communication unit 14 includes an interface such as a network interface card. The processing unit 15 performs various types of information processing. The processing unit 15 includes a processor such as a central processing unit (CPU) and a memory such as a read only memory (ROM) and a random access memory (RAM). The processing unit 15 performs information processing for controlling each unit of the printing device 10. The processing unit 15 performs control to transmit various types of information (described later) for managing the printing device 10 from the communication unit 14 to the management device 20.

The storage unit 16 stores information such as various programs and data. The storage unit 16 includes a storage such as a hard disk drive (HDD), a solid state drive (SSD), or a cloud storage.

The management device 20 includes a communication unit 21, a processing unit 22, and a storage unit 23. The management device 20 manages the printing device 10. As the management device 20, for example, various information processing devices such as a personal computer, a tablet, and a smartphone can be used. The management device 20 may be connected to an input unit (keyboard, mouse, touch panel, or the like) and an output unit (display unit, sound output unit, or the like) which are not illustrated.

The communication unit 21 performs wired or wireless communication with an external device including the printing device 10. The communication unit 21 includes an interface such as a network interface card.

The processing unit 22 performs various types of information processing. The processing unit 22 includes a processor such as a CPU and a memory such as a ROM and a RAM.

The processing unit 22 includes a maintenance information deriving unit 24, an evaluation unit 25, a fee calculation unit 26, and a related information deriving unit 27. The maintenance information deriving unit, the evaluation unit, the fee calculation unit, and the related information deriving unit may be separate units, or all or some of them may be integrated.

The maintenance information deriving unit 24 derives maintenance information related to an occurrence risk of maintenance work (assumed frequency of maintenance work) of the printing device 10. The maintenance information deriving unit 24 derives the maintenance information based on at least one of the operation record information related to the operation record of the printing device 10, the execution history information related to the execution history of the maintenance work of the printing device 10, the ink information related to the ink used for the printing device 10, the media information related to the medium to be printed by the printing device 10, and the installation environment information related to the installation environment of the printing device 10.

The operation record of the printing device 10 includes at least one of an energization time, the number of energization times, an operation time, the number of operations, a usage amount of ink, a printing area on a medium printed by the printing device 10, a printing success rate, and an error occurrence history. The operation record information may be original data related to the operation record, or may be processed data processed based on the original data related to the operation record. Examples of the processing data include time taken for each printing, an average value of time taken for one printing, an accumulated time taken for printing, and an accumulated time of idling.

The execution history information includes at least one of a cleaning execution history of the printing device 10, a station maintenance execution history of the printing device 10, a head maintenance execution history of the printing device 10, a wiper replacement history of the printing device 10, a number of times of periodic inspection of the printing device 10, a number of times of maintenance work other than malfunction repair and periodic inspection of the printing device 10, a number of times of replacement of a maintenance component of the printing device 10, a replacement interval of a maintenance component of the printing device 10, a usage record of a maintenance component of the printing device 10, a consumable used in the printing device 10, and a maintenance replacement used in the printing device 10.

The ink information includes at least one of information related to a type of the ink, information related to whether the ink is genuine, and information related to a component of the ink.

The media information includes at least one of information related to a type of the medium, information related to whether the medium is genuine, and information related to whether the medium is a recommended product.

The installation environment information includes at least one of temperature, humidity, altitude, and cleanliness of an installation place where the printing device 10 is installed, an inclination angle of a floor on which the printing device 10 is installed, an irradiation amount of ultraviolet rays at the installation place, information related to illuminance and luminance at the installation place, information related to a material of the floor, and information related to a structure of a building at the installation place.

The maintenance information deriving unit 24 can derive the maintenance information based on at least one of the number of times of maintenance work occurring within a predetermined period in the printing device 10, a cost of maintenance work of the printing device 10, and a cause of occurrence of maintenance work in the printing device 10.

The maintenance information deriving unit 24 can further derive the maintenance information based on the type of the maintenance work performed so far and the occurrence interval of the maintenance work.

The maintenance information can be, for example, stepwise values such as the occurrence risk “high”, “medium”, and “low”. The maintenance information deriving unit 24 may derive the maintenance information for each item to be subjected to maintenance work, such as a head, a cleaning unit, or the like, or may derive the maintenance information of the printing device 10 as a whole.

The evaluation unit 25 determines evaluation for the user of the printing device 10. The evaluation unit 25 determines the evaluation based on the maintenance information and at least one of the usage amount and the purchase amount of the consumable used in the printing device 10. Examples of the consumable include ink, media, and cleaning liquid.

In addition to the above, the evaluation unit 25 can further determine the evaluation for the user based on at least one of the number of the printing devices 10 owned, whether the maintenance history of the printing device 10 is recorded, the number of times of printing success and the number of times of error occurrence by the printing device 10, the usage amount of genuine media and genuine ink with respect to the entire printing time of the printing device 10, whether the maintenance of the printing device 10 is performed at a predetermined frequency, the replacement frequency of the maintenance component with respect to the entire printing time of the printing device 10 and the cost required for the replacement of the maintenance component, and the usage state of the replaced maintenance component.

Examples of the number of printing devices 10 owned include the total number of printing devices 10 owned by the user, the number of printing devices existing at the same installation place, the total number of printing devices 10 owned by the user so far, and the like.

The evaluation unit 25 can derive scoring information based on the derived maintenance information and an operation record of the printing device 10, and determine an evaluation for the user based on the scoring information.

The fee calculation unit 26 calculates a maintenance contract fee for maintenance work of the printing device 10. The fee calculation unit 26 calculates a maintenance contract fee based on the derived evaluation of the user.

The fee calculation unit 26 can calculate the grade of the user based on the calculated evaluation and calculate the maintenance contract fee based on the calculated grade. The grade can be set in a stepwise manner, such as a grade.

The fee calculation unit 26 can further calculate the maintenance contract fee based on the installation place of the printing device 10. The maintenance contract fee can be set as a fee system in which the amount of money changes in a stepwise manner, such as a rating system or a staircase system.

The fee calculation unit 26 can calculate a work fee each time, which is a work fee required every time maintenance of the printing device 10 is performed, based on the derived maintenance information.

The related information deriving unit 27 derives related information related to the printing device 10. The related information deriving unit 27 derives the related information based on at least one of the derived maintenance information and the evaluation of the user. The related information includes at least one of information related to a point to be improved by the user in using the printing device 10, information related to the soundness of the printing device 10, and information related to the maintenance time of the printing device 10.

The maintenance information deriving unit 24, the evaluation unit 25, the fee calculation unit 26, and the related information deriving unit 27 can derive the maintenance information, derive the evaluation, and calculate the maintenance contract fee based on a predetermined learning model. The learning model learns the maintenance information, the evaluation, and the maintenance contract fee in association with input items necessary for calculating or deriving the maintenance information, the evaluation, and the maintenance contract fee, and can output a value (maintenance information, evaluation, or maintenance contract fee) corresponding to a case where a predetermined input item is input. The learning model can be stored in the storage unit 23, for example.

The storage unit 23 stores information such as various programs and data. The storage unit 23 includes a storage such as an HDD or an SSD.

The storage unit 23 stores, for example, a management program of the printing device 10. A management program of the printing device 10 causes a computer to execute a maintenance information deriving step of deriving maintenance information related to an occurrence risk of a maintenance work of the printing device 10 based on at least one of operation record information related to an operation record of the printing device 10, execution history information related to an execution history of a maintenance work of the printing device 10, ink information related to ink used in the printing device 10, media information related to a medium to be printed by the printing device 10, and installation environment information related to an installation environment of the printing device 10, an evaluation step of deriving evaluation of a user of the printing device 10 based on the maintenance information and at least one of a usage amount and a purchase amount of a consumable used in the printing device 10, and a fee calculation step of calculating a maintenance contract fee for maintenance work of the printing device 10 based on the derived evaluation of the user.

In the management device 20, the processor in the processing unit 22 reads out various programs and develops the programs in the memory, thereby executing information processing corresponding to the functions of the above-described units. Examples of the various programs include a program received by the communication unit 21, a program stored in the storage unit 23, and a program recorded in an external recording medium. The management device 20 functions as an information processing device (computer) that executes various types of information processing. Note that another information processing device different from the management device 20 may execute various programs, or the management device 20 and another information processing device may execute various programs in cooperation.

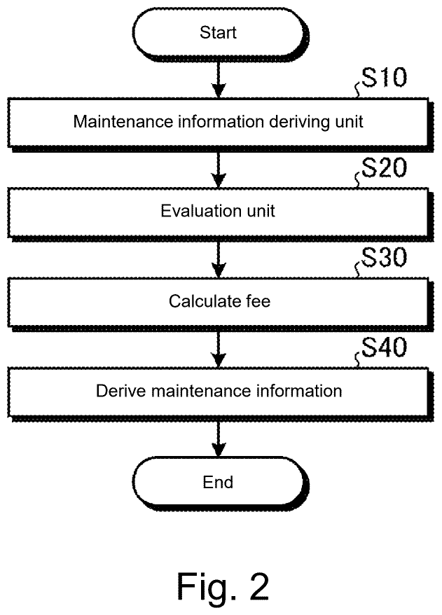

Next, an example of a management method of the printing device 10 using the management system 100 configured as described above will be described. FIG. 2 is a flowchart illustrating an example of a management method of the printing device 10 according to the present embodiment. As illustrated in FIG. 2, the management method of the printing device 10 according to the present embodiment includes a maintenance information deriving step S10, an evaluation step S20, a fee calculation step S30, and a related information deriving step S40.

In the maintenance information deriving step S10, the maintenance information deriving unit 24 collects various types of information such as operation record information, execution history information, ink information, media information, and installation environment information. Various types of information can be acquired from the printing device 10 by information communication via the communication unit 21. For example, when a maintenance worker of the printing device 10 performs maintenance work, various types of information such as a history of the maintenance work are registered in the printing device 10 by an operation panel or the like. In addition, the type of the replacement component, the content of the maintenance work, the replacement history of the component, the history of the maintenance work, and the like when various components are replaced or maintenance work is performed may be automatically registered in the printing device 10 by the one-dimensional barcode, the two-dimensional barcode, the various sensors, and the like. In the printing device 10, the registered various types of information are stored in the storage unit 16 of the printing device 10. The processing unit 15 causes the communication unit 14 to transmit various types of information stored in the storage unit 16 to the management device 20. The maintenance information deriving unit 24 collects various types of information transmitted from the printing device 10 and derives maintenance information based on the collected information.

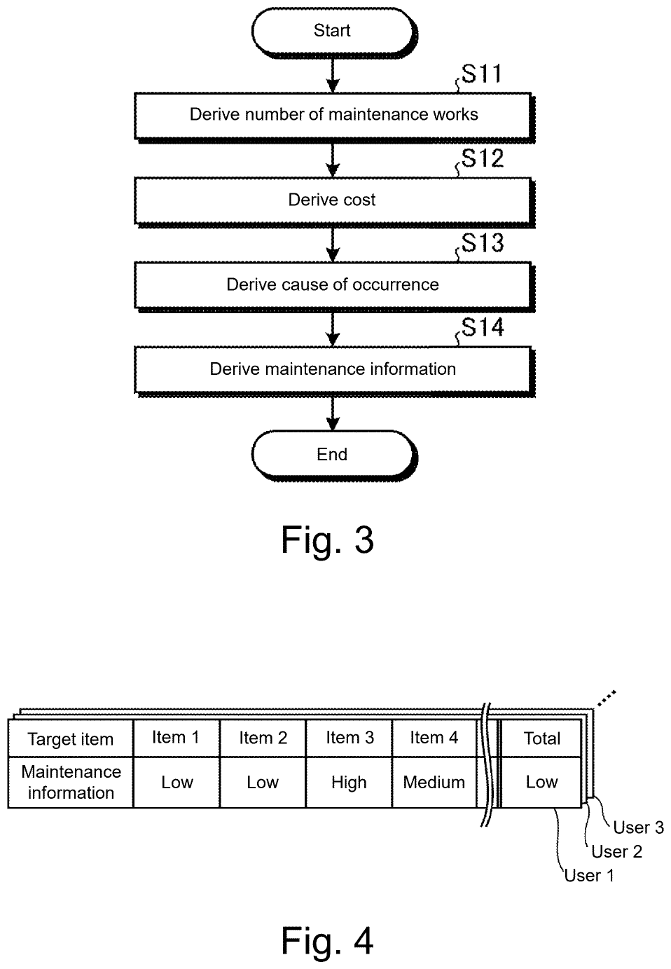

FIG. 3 is a flowchart illustrating an example of processing contents of the maintenance information deriving step S10. As illustrated in FIG. 3, for example, the maintenance information deriving unit 24 derives the number of times of maintenance work occurring within a predetermined period based on the collected information (step S11), derives the cost of the maintenance work occurring within the predetermined period (step S12), and derives the cause of occurrence of the maintenance work in the printing device 10 (step S13). The maintenance information deriving unit 24 can derive the maintenance information based on the content of each item derived in steps S11 to S13 (step S14). The maintenance information deriving unit 24 may further derive at least one of the type of the maintenance work and the occurrence interval of the maintenance work, and derive the maintenance information based on the derivation result and the derivation results in steps S11 to S13.

FIG. 4 is a diagram schematically illustrating an example of maintenance information derived in the maintenance information deriving step S10. As illustrated in FIG. 4, the maintenance information deriving unit 24 can derive the maintenance information for each user or each printing device 10. The maintenance information deriving unit 24 can store the derived maintenance information in the storage unit 23. The maintenance information deriving unit 24 may derive the maintenance information for each item to be subjected to maintenance work, or may derive the maintenance information of the printing device 10 as a whole. Note that the maintenance information deriving unit 24 can predict the cost to be generated each time maintenance work becomes necessary based on the derived maintenance information. For example, the maintenance information deriving unit 24 can predict, for example, the number of times of maintenance per year based on the maintenance information and predict an annual fee required for maintenance work. The maintenance information deriving unit 24 can display the prediction result on a display unit (not illustrated) or the like.

In the evaluation step S20, the evaluation unit 25 determines the evaluation for the user of the printing device 10 based on the maintenance information and at least one of the usage amount and the purchase amount of the consumable used in the printing device 10. The evaluation unit 25 can derive scoring information based on the derived maintenance information and an operation record of the printing device 10, and determine an evaluation for the user based on the scoring information.

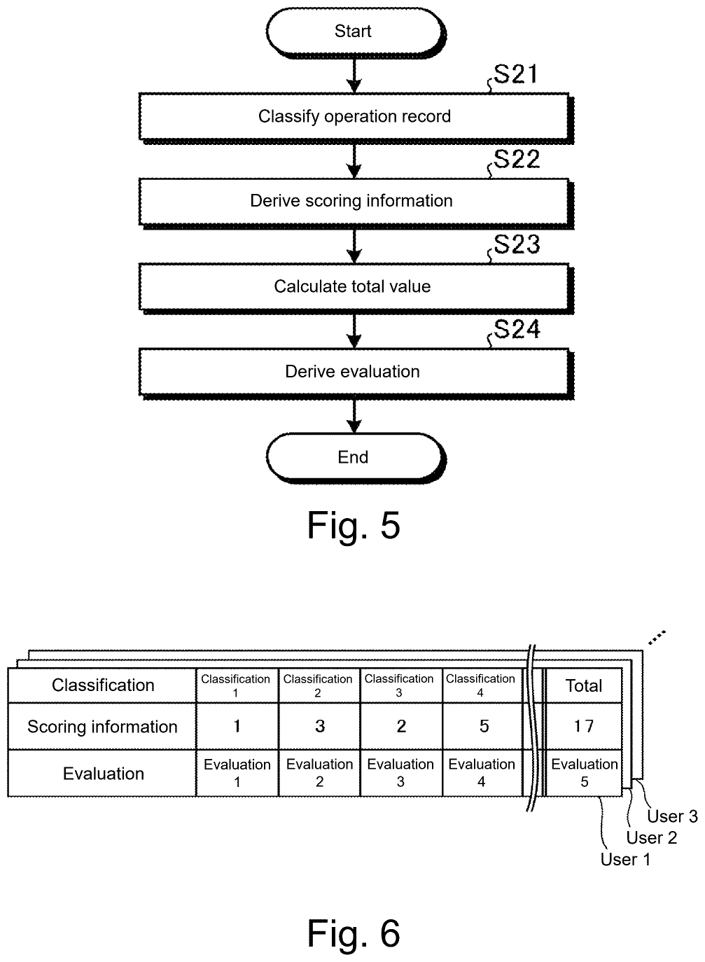

FIG. 5 is a flowchart illustrating an example of processing contents of the evaluation step S20. As illustrated in FIG. 5, for example, the evaluation unit 25 can classify the maintenance information derived in the maintenance information deriving step S10 and the operation record of the printing device 10 for each category (step S21), derive the scoring information for each classified category (step S22), calculate the total of the derived scoring information (step S23), and determine the evaluation for the user based on the calculation result (step S24).

FIG. 6 is a diagram schematically illustrating an example of evaluation derived in the evaluation step S20. As illustrated in FIG. 6, the evaluation unit 25 can derive the scoring information and the evaluation for each user or each printing device 10. The evaluation unit 25 can store the derived scoring information and evaluation in the storage unit 23. The evaluation unit 25 can derive the scoring information and the evaluation of the user as stepwise values such as scores and grades. The scoring information and the evaluation are not limited to the example illustrated in FIG. 6, and other aspects may be used.

Note that the health check and the like of the printing device 10 can be performed using the operation record information used for the evaluation of the user. In this case, the evaluation unit 25 can display a result of performing the health check of the printing device 10 on a display unit (not illustrated) or the like.

In the fee calculation step S30, the fee calculation unit 26 calculates a maintenance contract fee for maintenance work of the printing device 10. The fee calculation unit 26 calculates a maintenance contract fee based on the evaluation of the user derived in step S20.

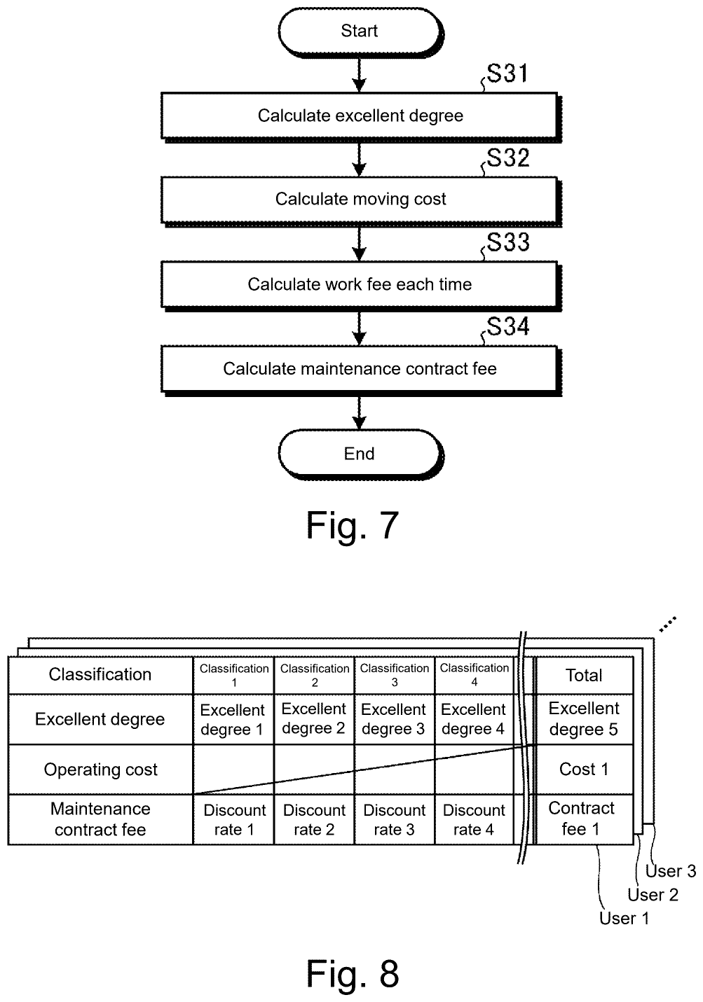

FIG. 7 is a flowchart illustrating an example of processing contents of the fee calculation step S30. As illustrated in FIG. 7, for example, the fee calculation unit 26 can calculate a grade of the user based on the evaluation calculated in step S20 (step S31), calculate a moving cost to the installation place based on the installation place of the printing device 10 (step S32), calculate a work fee each time necessary for performing maintenance of the printing device 10 based on the maintenance information derived in step S10 (step S33), and calculate a maintenance contract fee based on the calculated grade, moving cost, and work fee each time (step S34). For example, the fee calculation unit 26 can calculate the maintenance contract fee such that the higher the grade, the higher the discount rate. In addition, the fee calculation unit 26 can calculate the maintenance contract fee such that the discount rate becomes higher for a user with a longer period with a higher grade. In such a case, a user with higher grades will have lower maintenance contract fees. In addition, the fee calculation unit 26 may directly calculate the maintenance contract fee by the learning model using the evaluation in the evaluation step S20 as an input item. In this case, the maintenance contract fee can be dynamically set according to the evaluation.

FIG. 8 is a diagram schematically illustrating an example of a maintenance contract fee calculated in the fee calculation step S30. As illustrated in FIG. 8, the fee calculation unit 26 can derive the maintenance contract fee for each user or each printing device 10. The fee calculation unit 26 can store the derived maintenance contract fee in the storage unit 23. The fee calculation unit 26 can calculate the maintenance contract fee based on the grade and the moving cost. In addition to the maintenance contract fee, the fee calculation unit 26 can also present the calculated work fee each time to the user by displaying the work fee on a display unit (not illustrated) each time, for example. In addition, the final maintenance contract fee may be calculated by adding the fee calculated by the fee calculation unit to the maintenance basic fee for each model of the printing device.

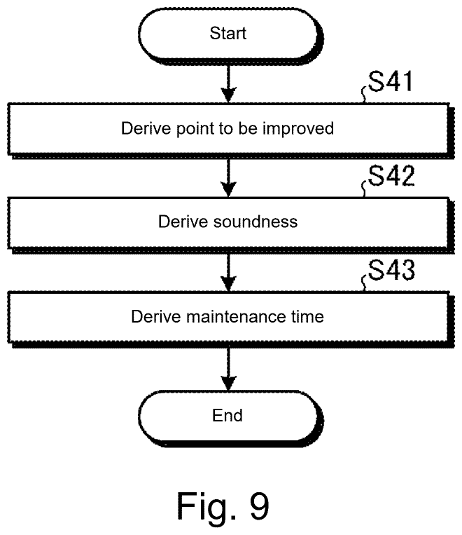

In the related information deriving step S40, the related information deriving unit 27 derives related information related to the printing device 10. FIG. 9 is a flowchart illustrating an example of processing contents of the related information deriving step S40. As illustrated in FIG. 9, for example, the related information deriving unit 27 specifies points to be improved by the user in using the printing device 10 (step S41), evaluates the soundness of the printing device 10 (step S42), and calculates the maintenance time of the printing device 10 (step S43). In steps S41 to S43, the related information deriving unit 27 can use at least one of the maintenance information derived in step S10 and the evaluation of the user derived in step S20.

For example, the related information deriving unit 27 can present a method for reducing the maintenance contract fee to the user based on the information by specifying a point to be improved by the user.

As described above, the management device (printing device management device) 20 according to the present embodiment includes a maintenance information deriving unit 24 that derives maintenance information related to an occurrence risk of a maintenance work of the printing device 10 based on at least one of operation record information related to an operation record of the printing device 10, execution history information related to an execution history of a maintenance work of the printing device 10, ink information related to ink used in the printing device 10, media information related to a medium to be printed by the printing device 10, and installation environment information related to an installation environment of the printing device 10, an evaluation unit 25 that determines an evaluation for a user of the printing device 10 based on the maintenance information and at least one of a usage amount and a purchase amount of a consumable used in the printing device 10, and a fee calculation unit 26 that calculates a maintenance contract fee for maintenance work of the printing device 10 based on the derived evaluation of the user.

In addition, a management method of the printing device 10 according to the present embodiment includes a maintenance information deriving step of deriving maintenance information related to an occurrence risk of a maintenance work of the printing device 10 based on at least one of operation record information related to an operation record of the printing device 10, execution history information related to an execution history of a maintenance work of the printing device 10, ink information related to ink used in the printing device 10, media information related to a medium to be printed by the printing device 10, and installation environment information related to an installation environment of the printing device 10, an evaluation step of determining evaluation for a user of the printing device 10 based on the maintenance information and at least one of a usage amount and a purchase amount of a consumable used in the printing device 10, and a fee calculation step of calculating a maintenance contract fee for maintenance work of the printing device 10 based on the derived evaluation of the user.

In addition, a management program of the printing device 10 according to the present embodiment causes a computer to execute a maintenance information deriving step of deriving maintenance information related to an occurrence risk of a maintenance work of the printing device 10 based on at least one of operation record information related to an operation record of the printing device 10, execution history information related to an execution history of a maintenance work of the printing device 10, ink information related to ink used in the printing device 10, media information related to a medium to be printed by the printing device 10, and installation environment information related to an installation environment of the printing device 10, an evaluation step of determining evaluation for a user of the printing device 10 based on the maintenance information and at least one of a usage amount and a purchase amount of a consumable used in the printing device 10, and a fee calculation step of calculating a maintenance contract fee for maintenance work of the printing device 10 based on the derived evaluation of the user.

In addition, the management system 100 of the printing device 10 according to the present embodiment includes the printing device 10, and a management device that is communicable with the printing device 10 and manages the printing device 10, in which the management device 20 is used as the management device.

According to these configurations, the user is evaluated based on the past use history and maintenance history of the printing device 10 by the user, and the maintenance contract fee is calculated based on the evaluation result, whereby the occurrence risk, cost, and the like of the maintenance work that will occur in the future can be appropriately estimated. Accordingly, an appropriate maintenance contract fee for maintenance work of the printing device can be calculated. In addition, it is possible to set an appropriate discount rate by evaluating the user from the viewpoint of whether consumables recommended by the manufacturer are used.

In the management device 20 according to the present embodiment, the operation record information includes at least one of an energization time, the number of energization times, an operation time, the number of operations, a usage amount of ink, a printing area on a medium printed by the printing device 10, a printing success rate, and an error occurrence history. According to this configuration, the maintenance information can be appropriately derived.

In the management device 20 according to the present embodiment, the execution history information includes at least one of a cleaning execution history of the printing device 10, a station maintenance execution history of the printing device 10, a head maintenance execution history of the printing device 10, a wiper replacement history of the printing device 10, a number of times of periodic inspection of the printing device 10, a number of times of maintenance work other than malfunction repair and periodic inspection of the printing device 10, a number of times of replacement of a maintenance component of the printing device 10, a replacement interval of a maintenance component of the printing device 10, a usage record of a maintenance component of the printing device 10, a consumable used in the printing device 10, and a maintenance replacement used in the printing device 10. According to this configuration, the maintenance information can be appropriately derived.

In the management device 20 according to the present embodiment, the ink information includes at least one of information related to a type of the ink, information related to whether the ink is genuine, and information related to a component of the ink. According to this configuration, the maintenance information can be appropriately derived.

In the management device 20 according to the present embodiment, the media information includes at least one of information related to a type of the medium, information related to whether the medium is genuine, and information related to whether the medium is a recommended product. According to this configuration, the maintenance information can be appropriately derived.

In the management device 20 according to the present embodiment, the installation environment information includes at least one of temperature, humidity, altitude, and cleanliness of an installation place where the printing device 10 is installed, an inclination angle of a floor on which the printing device 10 is installed, an irradiation amount of ultraviolet rays at the installation place, information related to illuminance and luminance at the installation place, information related to a material of the floor, and information related to a structure of a building at the installation place. According to this configuration, the maintenance information can be appropriately derived.

In the management device 20 according to the present embodiment, the evaluation unit 25 further determines the evaluation of the user based on the number of owned printing devices 10. According to this configuration, the user can be appropriately evaluated.

In the management device 20 according to the present embodiment, the evaluation unit 25 further determines the evaluation of the user based on at least one of whether the maintenance history of the printing device 10 is recorded, the number of printing successes and the number of error occurrences by the printing device 10, the usage amount of genuine media and genuine ink with respect to the entire printing time of the printing device 10, whether the maintenance of the printing device 10 is performed at a predetermined frequency, the replacement frequency of the maintenance component with respect to the entire printing time of the printing device 10, the cost required for replacing the maintenance component, and the usage state of the replaced maintenance component. According to this configuration, the user can be appropriately evaluated.

In the management device 20 according to the present embodiment, the fee calculation unit 26 calculates a grade of the user, which is a stepwise value, based on the calculated evaluation, and calculates the maintenance contract fee based on the calculated grade. According to this configuration, since the maintenance contract fee is calculated based on the grade which is a stepwise value, it is possible to easily estimate the cost at the time of updating the maintenance contract.

In the management device 20 according to the present embodiment, the fee calculation unit 26 further calculates the maintenance contract amount based on the installation place of the printing device 10. According to this configuration, the cost, including the moving cost between the base and the installation place, can be calculated when the maintenance worker departs from the base.

In the management device 20 according to the present embodiment, the fee calculation unit 26 calculates a work fee each time required when maintenance of the printing device 10 is performed based on the derived maintenance information. According to this configuration, the calculated maintenance contract fee and the work fee each time can be compared and presented to the user. The user may compare the presented maintenance contract fee to the work fee each time and select which is better.

In the management device 20 according to the present embodiment, the related information deriving unit 27 that derives related information related to the printing device 10 based on at least one of the derived maintenance information and the evaluation of the user is further included. According to this configuration, by deriving the related information, it is possible to present a wide range of information to the user in the execution of the maintenance contract.

In the management device 20 according to the present embodiment, the related information includes at least one of information related to an improvement point in use of the printing device 10, information related to the soundness of the printing device 10, and information related to a maintenance time of the printing device 10. According to this configuration, the number of maintenance works can be reduced by presenting the user with the improvement point of the use of the printing device 10. In addition, by presenting the information related to the soundness of the printing device 10 and the information regarding the maintenance time of the printing device 10 to the user, it is possible to make it easy for the user to ascertain the maintenance occurrence time. The user can use the printing device 10 in a planned and efficient manner by ascertaining the maintenance occurrence time.

In the management device 20 according to the present embodiment, the maintenance information deriving unit 24 further derives the maintenance information based on at least one of the number of times of maintenance work occurring within a predetermined period in the printing device 10, a cost of maintenance work of the printing device 10, and a cause of occurrence of maintenance work in the printing device 10. According to this configuration, it is possible to determine whether the maintenance work has occurred due to any cause, such as a cause in which the manufacturer is responsible, a cause in which the user is responsible, and a natural disaster, which is neither the responsibility of the manufacturer nor the responsibility of the user, and derive the maintenance information based on the determination result, and thus, it is possible to more appropriately derive the maintenance information.

In the management device 20 according to the present embodiment, the maintenance information deriving unit 24 further derives the maintenance information based on the type of maintenance work and the occurrence interval of the maintenance work. According to this configuration, the maintenance information can be more appropriately derived.

In the management device 20 according to the present embodiment, the maintenance information deriving unit 24, the evaluation unit 25, and the fee calculation unit 26 derive maintenance information, derive evaluation, and calculate a maintenance contract fee based on a predetermined learning model. According to this configuration, the maintenance contract fee can be calculated more appropriately.

In the management device 20 according to the present embodiment, the evaluation unit 25 derives scoring information based on the derived maintenance information and an operation record of the printing device 10, and determines an evaluation for the user based on the scoring information. According to this configuration, the user can be evaluated in more detail by using the scoring information.

The technical scope of the present invention is not limited to the above embodiment, and can be appropriately changed without departing from the gist of the present invention. For example, in the above embodiment, the case where the management device 20 is a device separate from the printing device 10 has been described as an example, but the present invention is not limited to this configuration. The management device 20 may be provided inside the printing device 10. In this case, each function of the processing unit 22 of the management device 20 can be provided in the processing unit 15 of the printing device 10.

For example, the printing device 10 can be configured to include a maintenance information deriving unit 24 that derives maintenance information related to an occurrence risk of a maintenance work of the printing device 10 based on at least one of operation record information related to an operation record of the printing device 10, execution history information related to an execution history of a maintenance work of the printing device 10, ink information related to ink used in the printing device 10, media information related to a medium to be printed by the printing device 10, and installation environment information related to an installation environment of the printing device 10, and an evaluation unit 25 that derives an evaluation of a user of the printing device 10 based on the maintenance information and at least one of a usage amount and a purchase amount of a consumable used in the printing device 10. In this case, the configuration corresponding to the fee calculation unit 26 may not be provided in the printing device 10.

### REFERENCE SIGNS LIST

M Media
NW Network
10 Printing device
11 Main body
12 Head
13 Control unit
14,21 Communication unit
15, 22 Processing unit
16, 23 Storage unit
20 Management device
24 Maintenance information deriving unit
25 Evaluation unit
26 Fee calculation unit
27 Related information deriving unit
31 Transporting unit
32 Head drive unit
33 Ink supply unit
34 Cleaning unit
35 Operation panel
36 Ultraviolet irradiation unit
100 Management system

1. A printing device management device comprising:
a maintenance information deriving unit that derives maintenance information related to an occurrence risk of a maintenance work of a printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device;
an evaluation unit that derives an evaluation for a user of the printing device based on the maintenance information and at least one of a usage amount of a consumable used in the printing device and a purchase amount of the consumable; and
a fee calculation unit that calculates a maintenance contract fee for maintenance work of the printing device based on the derived evaluation of the user.

2. The printing device management device as set forth in claim 1, wherein the operation record information includes at least one of an energization time, a number of energization times, an operation time, a number of operations, a usage amount of the ink, a printing area on the medium printed by the printing device, a printing success rate, and an error occurrence history.

3. The printing device management device as set forth in claim 1, wherein the execution history information includes at least one of a cleaning execution history of the printing device, a station maintenance execution history of the printing device, a head maintenance execution history of the printing device, a wiper replacement history of the printing device, a number of times of periodic inspection of the printing device, a number of times of maintenance work other than malfunction repair and periodic inspection of the printing device, a number of times of replacement of a maintenance component of the printing device, a replacement interval of a maintenance component of the printing device, a usage record of a maintenance component of the printing device, a consumable used in the printing device, and a maintenance replacement used in the printing device.

4. The printing device management device as set forth in claim 1, wherein the ink information includes at least one of information related to a type of the ink, information related to whether the ink is genuine, and information related to a component of the ink.

5. The printing device management device as set forth in claim 1, wherein the media information includes at least one of information related to a type of the medium, information related to whether the medium is genuine, and information related to whether the medium is a recommended product.

6. The printing device management device as set forth in claim 1, wherein the installation environment information includes at least one of temperature, humidity, altitude, and cleanliness of an installation place where the printing device is installed, an inclination angle of a floor on which the printing device is installed, an irradiation amount of ultraviolet rays at the installation place, information related to illuminance and luminance at the installation place, information related to a material of the floor, and information related to a structure of a building at the installation place.

7. The printing device management device as set forth in claim 1, wherein the evaluation unit further derives the evaluation of the user based on the number of the printing devices owned.

8. The printing device management device as set forth in claim 1, wherein the evaluation unit further derives the evaluation of the user based on at least one of whether a maintenance history of the printing device is recorded, the number of printing successes and the number of error occurrences by the printing device, the usage amount of the genuine medium and the genuine ink with respect to the entire printing time of the printing device, whether maintenance of the printing device is implemented at a predetermined frequency, a replacement frequency of a maintenance component and a cost required for replacing the maintenance component with respect to the entire printing time of the printing device, and a usage state of the replaced maintenance component.

9. The printing device management device as set forth in claim 1, wherein the fee calculation unit calculates a grade of the user, which is a stepwise value, based on the calculated evaluation, and calculates the maintenance contract fee based on the calculated grade.

10. The printing device management device as set forth in claim 1, wherein the fee calculation unit further calculates the maintenance contract fee based on an installation place of the printing device.

11. The printing device management device as set forth in claim 1, wherein the fee calculation unit calculates a work fee each time required each time when maintenance of the printing device is performed based on the derived maintenance information.

12. The printing device management device as set forth in claim 1, further comprising:
a related information deriving unit that derives related information related to the printing device based on at least one of the derived maintenance information and the evaluation of the user.

13. The printing device management device as set forth in claim 12, wherein the related information includes at least one of information related to an improvement point in use of the printing device, information related to soundness of the printing device, and information related to a maintenance time of the printing device.

14. The printing device management device as set forth in claim 1, wherein the maintenance information deriving unit further derives the maintenance information based on at least one of the number of times of maintenance work occurring within a predetermined period in the printing device, a cost of maintenance work of the printing device, and a cause of occurrence of maintenance work in the printing device.

15. The printing device management device as set forth in claim 1, wherein the maintenance information deriving unit further derives the maintenance information based on a type of the maintenance work and an occurrence interval of the maintenance work.

16. The printing device management device as set forth in claim 1, wherein the maintenance information deriving unit, the evaluation unit, and the fee calculation unit derive the maintenance information, derive the evaluation, and calculate the maintenance contract fee based on a predetermined learning model.

17. The printing device management device as set forth in claim 1, wherein the evaluation unit derives scoring information based on the derived maintenance information and an operation record of the printing device, and determines an evaluation for the user based on the scoring information.

18. A printing device management method comprising:
a maintenance information deriving step of deriving maintenance information related to an occurrence risk of a maintenance work of the printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device;
an evaluation step of deriving evaluation of a user of the printing device based on the maintenance information and at least one of a usage amount of a consumable used in the printing device and a purchase amount of the consumable; and
a fee calculation step of calculating a maintenance contract fee for maintenance work of the printing device based on the derived evaluation of the user.

19. (canceled)

20. A printing device management system comprising:
a printing device; and
a management device that is communicable with the printing device and manages the printing device, wherein
the printing device management device as set forth in claim 1 is used as the management device.

21. A printing device comprising:
a maintenance information deriving unit that derives maintenance information related to an occurrence risk of a maintenance work of the printing device based on at least one of operation record information related to an operation record of the printing device, execution history information related to an execution history of a maintenance work of the printing device, ink information related to ink used in the printing device, media information related to a medium to be printed by the printing device, and installation environment information related to an installation environment of the printing device; and
an evaluation unit that derives an evaluation of a user of the printing device based on the maintenance information and at least one of a usage amount of a consumable used in the printing device and a purchase amount of the consumable.
